(19) United States
(12) Patent Application Publication
(10) Pub. No.: US 2017/0177098 A1
(43) Pub. Date: Jun. 22, 2017

(54) Tethered Active Stylus

(71) Applicant: EGALAX_EMPIA TECHNOLOGY INC., Taipei City (TW)

(72) Inventors: CHIN-FU CHANG, Taipei City (TW); SHANG-TAI YEH, TAIPEI CITY (TW); YU-HAO CHANG, TAIPEI CITY (TW)

(21) Appl. No.: 15/379,821

(22) Filed: Dec. 15, 2016

Related U.S. Application Data
(60) Provisional application No. 62/268,760, filed on Dec. 17, 2015.

(51) Int. Cl. G06F 3/0354

(52) U.S. Cl. CPC G06F 3/03545

(57) ABSTRACT

The present invention provides a tethered active stylus, including: a conductive tip; and a driving-signal line coupled to the conductive tip, wherein the driving-signal line is configured to connect with a driving circuit of a touch controller, and the driving circuit is configured to provide driving signals to multiple electrodes of a touch screen controlled by the touch controller and the driving-signal line.

### CROSS REFERENCES TO RELATED APPLICATIONS

This application claims priority of U.S. provisional patent application, 62/268,760, filed on Dec. 17, 2015, the disclosure of which is incorporated herein by reference.

### FIELD OF THE INVENTION

The present invention relates to a stylus, and more particularly, to a tethered active stylus.

### BACKGROUND OF THE INVENTION

Touch sensitive input methods are widely used in input/output (I/O) devices for modern consumer electronic systems. In many applications, in addition to touch control by fingers, a stylus can also be used for more precise control, such as in handwriting recognition or image processing. Compared to a passive stylus that does not emit signals, an active stylus that can actively transmit electrical signals has higher accuracy, but at a cost several times the cost of the former.

A wireless active stylus is limited in power, and typically at a higher cost than a tethered stylus. However, an existing tethered active stylus uses a proprietary electrical signal, and a corresponding touch controller needs to develop an additional detection mode to detect the proprietary electrical signal in order to know the position and/or state of the tethered active stylus. Therefore, a need for a tethered active stylus and touch system that is capable of minimizing the cost, such that the tethered active stylus can be made available as a standard accessory for electronic systems at no great cost.

### SUMMARY OF THE INVENTION

In accordance with an embodiment, a tethered active stylus is provided, including: a conductive tip; and a driving-signal line electrically coupled to the conductive tip, wherein the driving-signal line is connected to a driving circuit of a touch controller, and the driving circuit sequentially provides a driving signal to a plurality of electrodes on a touch screen connected with the touch controller and the driving-signal line in a time-division multiplexing manner. One advantage of this embodiment is that the driving circuit of the touch controller is used repeated, thus saving the cost for additional driving circuits.

In the above embodiment, the driving signals provided to the plurality of electrodes and the driving-signal line are the same. One advantage of this embodiment is that the same driving signal is used, thus eliminating the cost of developing an additional detection circuit in the touch controller.

In the above embodiment, the tethered active stylus further includes a ground line electrically coupled to a ground potential of the touch controller. In an example, the tethered active stylus further includes a conductive core electrically coupled between the conductive tip and the driving-signal line; a core insulating material surrounding the conductive core; and a core shielding element surrounding the core insulating material, the core shielding element is conductive and electrically coupled to the ground line. In an example, a portion of the core insulating material near the conductive tip is not covered by the core insulating element. In an example, a portion of the core insulating material near the conductive tip protrudes from the body of the stylus. In an example, the tethered active stylus further includes i switches. Each switch is located between the ground line and a switch line of the touch controller, wherein i is a positive integer. The advantage of this embodiment is that a simple structure can be used for making an anti-interference tethered active stylus while providing multiple switches.

In the above embodiment, the tethered active stylus further includes a pressure sensor for sensing a force experienced at the conductive tip and transmitting a force value experienced at the conductive tip back to the touch controller via a wire. In an example, the pressure sensor includes: a first element having a first impedance that changes with the force experienced for receiving a first signal including a first frequency group; a second element having a second impedance that does not change with the force experienced for receiving a second signal including a second frequency group; and a sensing line for receiving output signals from the first element and the second element. In an example, the force value returned by the sensing line is represented by a ratio of the signal strength M1 of the first frequency group and the signal strength M2 of the second frequency group. One advantage of this embodiment is that, in addition to providing a force sensor composed of simple passive elements, accurate sensing pressure at the tip can also be provided while reducing the cost.

In accordance with an embodiment, a tethered active stylus is provided, including: a conductive tip; and a pressure sensor including: a first element having a first impedance that changes with the force experienced for receiving a first signal including a first frequency group from a touch controller; and a second element having a second impedance that does not change with the force experienced for receiving a second signal including a second frequency group from the touch controller; wherein the conductive tip is at least coupled to one of the first element and the second element. One advantage of this embodiment is that, in addition to providing a force sensor composed of simple passive elements, accurate sensing pressure at the tip can also be provided while reducing the cost.

In the above embodiment, the pressure sensor further includes a sensing line for transmitting the force experience at the conductive tip back to the touch controller. In an example, the sensing line receives output signals from the first element and the second element, and the force value returned by the sensing line is represented by a ratio of the signal strength M1 of the first frequency group and the signal strength M2 of the second frequency group.

In the above embodiment, the tethered active stylus further includes a ground line electrically coupled to a ground potential of the touch controller. In an example, the tethered active stylus further includes i switches. Each switch is located between the ground line and a switch line of the touch controller, wherein i is a positive integer. One advantage of this embodiment is that multiple switches can be provided.

In accordance with an embodiment of the present invention, a touch controller is provided, including: a driving circuit; and a multiplexing circuit module for sequentially providing a driving signal provided by the driving circuit to a plurality of first electrodes on a touch screen and a driving-signal line electrically coupled with a conductive tip of a tethered active stylus in a time-division multiplexing manner. One advantage of this embodiment is that the driving circuit of the touch controller is used repeated, thus saving the cost for additional driving circuits.

In the above embodiment, the multiplexing circuit module further includes a first multiplexing circuit for connecting a portion of the plurality of first electrodes; and a second multiplexing circuit for connecting another portion of the plurality of first electrodes and the driving-signal line. One advantage of this embodiment is that the multiplexing circuits of the touch controller are used repeated, thus saving the cost for additional driving circuits.

In the above embodiment, the touch controller further includes a sensing circuit connected to a plurality of second electrodes and the plurality of first electrodes on the touch screen for determining, when the driving signal is provided by the driving circuit, a location of proximity/touch of the tethered active stylus based on driving signals sensed from the plurality of first electrodes and the plurality of second electrodes. One advantage of this embodiment is that the same driving signal is used, thus eliminating the cost of developing an additional detection circuit in the touch controller.

In accordance with an embodiment of the present invention, a touch control method is provided, including: sequentially providing a driving signal to a plurality of first electrodes on a touch screen and a driving-signal line electrically coupled with a conductive tip of a tethered active stylus in a time-division multiplexing manner; and determining, when the driving signal is provided to the driving-signal line, a location of proximity/touch of the tethered active stylus based on driving signals sensed from the plurality of first electrodes and the plurality of second electrodes. One advantage of this embodiment is that the multiplexing circuits of the touch controller are used repeated, thus saving the cost for additional driving circuits. Also, the same driving signal is used, thus eliminating the cost of developing an additional detection circuit in the touch controller.

In accordance with an embodiment of the present invention, a touch control system is provided, including: a tethered active stylus and a touch controller. The tethered active stylus includes a conductive tip; and a driving-signal line electrically coupled to the conductive tip. The touch controller includes: a driving circuit; and a multiplexing circuit module for sequentially providing a driving signal provided by the driving circuit to a plurality of first electrodes on a touch screen and the driving-signal line in a time-division multiplexing manner. One advantage of this embodiment is that the multiplexing circuits of the touch controller are used repeated, thus saving the cost for additional driving circuits. Also, the same driving signal is used, thus eliminating the cost of developing an additional detection circuit in the touch controller.

In the above embodiment, the tethered active stylus further includes a ground line electrically coupled to a ground potential of the touch controller. In an example, the tethered active stylus further includes a conductive core electrically coupled between the conductive tip and the driving-signal line; a core insulating material surrounding the conductive core; and a core shielding element surrounding the core insulating material, the core shielding element is conductive and electrically coupled to the ground line. In an example, the core insulating material near the conductive tip is not covered by the core insulating element. In an example, the core insulating material near the conductive tip protrudes from the body of the stylus. In an example, the tethered active stylus further includes i switches. Each switch is located between the ground line and a switch line of the touch controller, wherein i is a positive integer. In the above embodiment, the tethered active stylus further includes a pressure sensor for sensing a force experienced at the conductive tip and transmitting a force value experienced at the conductive tip back to the touch controller via a wire. In an example, the pressure sensor includes: a first element having a first impedance that changes with the force experienced for receiving a first signal including a first frequency group; a second element having a second impedance that does not change with the force experienced for receiving a second signal including a second frequency group; and a sensing line for receiving output signals from the first element and the second element. In an example, the force value returned by the sensing line is represented by a ratio of the signal strength M1 of the first frequency group and the signal strength M2 of the second frequency group.

In the above embodiment, the touch control system further includes a connection interface between the touch controller and the tethered active stylus for electrically coupling the driving-signal line. In an example, the connection interface is further used for electrically coupling the ground line. One advantage of this embodiment is that a plug-in connection interface that allows easy replacement of the tethered active stylus.

### BRIEF DESCRIPTION OF THE DRAWINGS

FIG. 1 is a schematic diagram depicting an electronic apparatus 100 in accordance with an embodiment of the present invention.

FIG. 2 is a cross-sectional schematic diagram depicting a stylus 130 in accordance with an embodiment of the present invention.

FIG. 3 is a diagram depicting the outer appearance of a core 131 of the stylus in accordance of the present invention.

FIG. 4A is a block diagram depicting a tethered stylus 400 in accordance with an embodiment of the present invention.

FIG. 4B is a circuit diagram depicting a pressure sensor 410 in accordance with an embodiment of the present invention.

FIG. 5 is a schematic diagram depicting a stylus 500 in accordance with an embodiment of the present invention.

FIG. 6 is a schematic diagram depicting a stylus 600 in accordance with an embodiment of the present invention.

FIG. 7 is a schematic diagram depicting a stylus 700 in accordance with an embodiment of the present invention.

FIG. 8 is a schematic diagram depicting a stylus 800 in accordance with an embodiment of the present invention.

FIG. 9 is a schematic diagram depicting a stylus 900 in accordance with an embodiment of the present invention.

FIG. 10 is a schematic diagram depicting a stylus 1000 in accordance with an embodiment of the present invention.

FIG. 11 is a schematic diagram depicting a stylus 1100 in accordance with an embodiment of the present invention.

FIG. 12 a schematic diagram depicting a stylus 1200 in accordance with an embodiment of the present invention.

FIG. 13 a schematic diagram depicting a stylus 1300 in accordance with an embodiment of the present invention.

FIG. 14 is a schematic diagram depicting the inside of the touch controller 120 in accordance with an embodiment of the present invention.

FIG. 15 is a flowchart illustrating a touch control method in accordance with the present invention.

FIG. 16 is a block diagram illustrating an electronic apparatus 1600 in accordance with an embodiment of the present invention.

FIG. 17 is a flowchart illustrating a control method for a touch controller in accordance with an embodiment of the present invention.

FIG. 18 is a flowchart illustrating a control method of an onboard controller in accordance with an embodiment of the present invention.

### DETAILED DESCRIPTION OF THE EMBODIMENTS

The present invention is described by the following specific embodiments. However, in addition to those embodiments disclosed herein, the present invention can be widely applied to other embodiments. The scope of the present invention is not limited by these embodiments, but rather those set forth in the claims. In order to facilitate a clear description and for those skilled in the art to readily understand the contents of the present invention, some portions of the diagrams are not drawn to scale; ratios of some elements with respect to other elements are exaggerated; and some details that are not relevant to the present invention are omitted for conciseness of the diagrams.

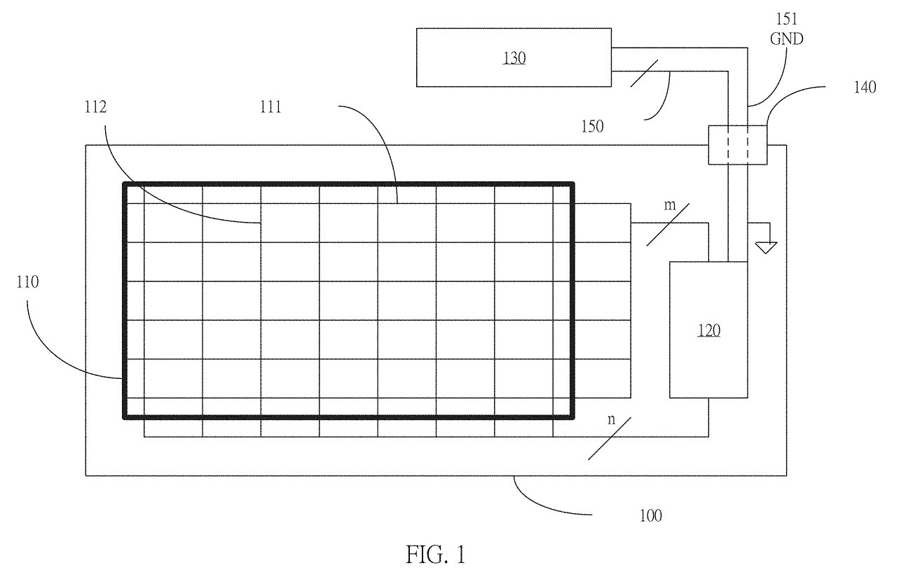

Referring to FIG. 1, a schematic diagram depicting an electronic apparatus 100 in accordance with an embodiment of the present invention is shown. The electronic apparatus 100 includes a touch panel or a touch screen 110 (hereinafter, the term “touch screen” is used to refer to both of these terms for convenience). The touch screen 110 is provided with a plurality of parallel first electrodes 111 and a plurality of parallel second electrodes 112, forming a plurality of intersections on the touch screen. The electronic apparatus 100 further includes a touch controller 120 connected to the first and second electrodes 111 and 112, which may include a microprocessor or an embedded processor for executing programs in order to carry out touch sensitive functions for the touch screen 110. The touch sensitive functions may include detecting, on the touch screen 110, the proximity or touch (hereafter proximity/touch) of an external conductive object, such as a finger, and a stylus 130 that actively transmits electrical signals.

In an embodiment, the electronic apparatus 100 includes the stylus 130 connected to the touch controller 120, and a connection interface 140. The connection interface 140 may be a plug-in, a magnetic-suction, or a threaded connection interface or the like; the present invention is not limited as such. The connection interface 140 includes a plurality of wires 150; the present invention does not limit the number of wires 150 that can be included in the connection interface. There is a bus connection between the stylus 130 and the connection interface 140. The bus connection may include a shielding layer for preventing any external interference. Each of the wires 150 inside the bus connection may also include a shielding layer. The wires 150 can be spirally intertwined to minimize crosstalk and interference.

In another embodiment, the stylus 130 and the touch controller 120 have no connection interface 140 between them, instead wires 150 are directly used for connection in order to increase robustness and reliability of the system.

In an embodiment, the bus connection includes a ground line 151 for connecting to the ground potential of the touch controller 120 or the ground potential of the electronic apparatus 100.

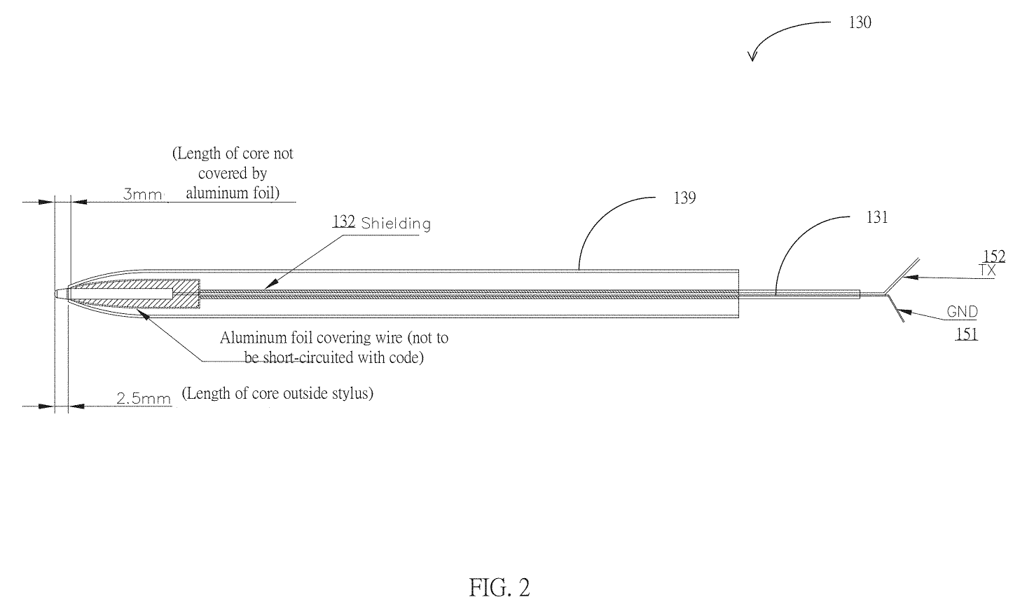

Referring to FIG. 2, a cross-sectional schematic diagram depicting a stylus 130 in accordance with an embodiment of the present invention is shown. The stylus 130 shown in FIG. 2 can be applied to the embodiment shown in FIG. 1. The bus connection of the stylus 130 includes two wires 150; one is the ground line 151 (GND) described above, and the other is a driving-signal line 152 (TX).

In an embodiment, the driving-signal line 152 can be connected to one of a plurality of driving circuits of the touch screen processor 120. Each of these driving circuits are connected to a respective first electrode 111 described above. The touch screen processor 120 may use the first electrodes 111 as the driving electrodes by sequentially providing a driving signal to each of the first electrodes 111 in turn, and performing detection on each of the second electrodes 112; more specifically, performing mutual capacitive detection to determine whether there is a proximity/touch event of an external conductive object. The touch screen processor 120 may perform detection using each of the first and second electrodes in order to detect a driving signal transmitted by the tip of the stylus 130. The proximity/touch location of the tip of the stylus 130 can then be determined based on the magnitudes of the driving signals received at the various electrodes.

For convenience, in an embodiment, the driving signal provided to the driving-signal line of the stylus 130 and the driving signal provided to each of the first electrodes 111 during mutual-capacitive detection by the touch controller 120 are the same. Thus, the touch controller 120 may connect a driving circuit that is not being used to the stylus 130 to implement this embodiment.

As shown in FIG. 2, the core 131 of the stylus 130 is a conductor, and the right hand side (i.e. away from the head of the stylus 130) of which is connected to the driving-signal line 152 (TX). The core 131 is covered by a core insulating material, which is in turn covered by another conductive material, such as an aluminum foil, a copper foil, graphite or the like. This conductive material (or called core shielding element 132) is used for shielding magnetic interference of the driving signal except at the direction of the stylus head, as well as shielding the core from any external magnetic signals. The core shielding element is connected to the ground line 151 (GND).

In an embodiment, about 3 mm of the core insulating material near the head or the tip of the stylus 130 is not covered by the core shielding element, and about 2.5 mm of the core insulating material protrudes from the body of the stylus 130.

The ground line 151 (GND) and the driving-signal line 152 (TX) are inside the body of the stylus 130, preferably in the center thereof. In an embodiment, each of the wires 150 in the stylus body also includes a conductive shielding layer. In another embodiment, a conductive shielding layer covers the overall of the wires inside the stylus body. In another embodiment, the wires inside the stylus body are twisted. These measures are to prevent cross-talk between the wires, as well as to prevent the wires from external interference. Obviously, the wires can also have no protection measures in order to save cost.

The stylus body shown in FIG. 2 can be formed integrally, or it can have hollow tube walls for receiving the core 131 and the internal wires 150 described above. In an embodiment, the core insulating material and the stylus body 139 are both made of an insulating material such as resin, synthetic resin, plastic, or the like.

In an embodiment of a method for making the stylus 130, the internal wires 150 in the middle of the stylus body 139 can be manufactured first, and then the driving-signal line 152 of the internal wires 150 is connected to the stylus core 131. Next, a mold is used to cover the core 131 with the core insulating material, then the core insulating material is covered with the core shielding element 132, and the ground line 151 of the internal wires is connected to the core insulating material. Finally, a mold is used to enclose the components covered by the core shielding element 132 and the internal wires 150, and a stylus body material is filled into the enclosed space to form the stylus. In this embodiment, since the insulating material of the stylus body needs to be melted into liquid, the melting point of the core insulating material should be higher than that of the stylus body so as to prevent the core insulating material from melting into liquid during filling of the stylus body material.

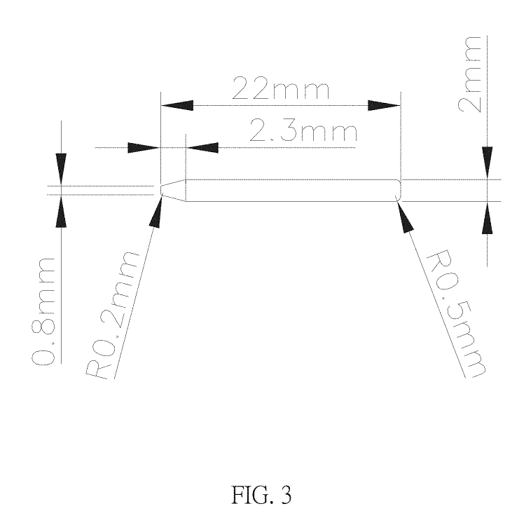

Referring to FIG. 3, a diagram depicting the outer appearance of the core 131 of the stylus in accordance of the present invention is shown. The core can be a casted piece or a cut piece. The dimensions of the core are shown in FIG. 3. The left hand side of the core is the head or the tip of the core. The tip shown in FIG. 3 can be used in other embodiments of the present application.

The stylus 130 shown in the embodiment of FIG. 2 can only be used to indicate the proximity/touch location, allowing the touch controller 120 to obtain the location of the stylus 130 through the various electrodes 111 and 112, but not the pressure experienced at the tip of the stylus 130. Therefore, one of the objectives of the following embodiments is to allow the touch controller 120 to obtain the pressure experienced at the tip of the stylus 130.

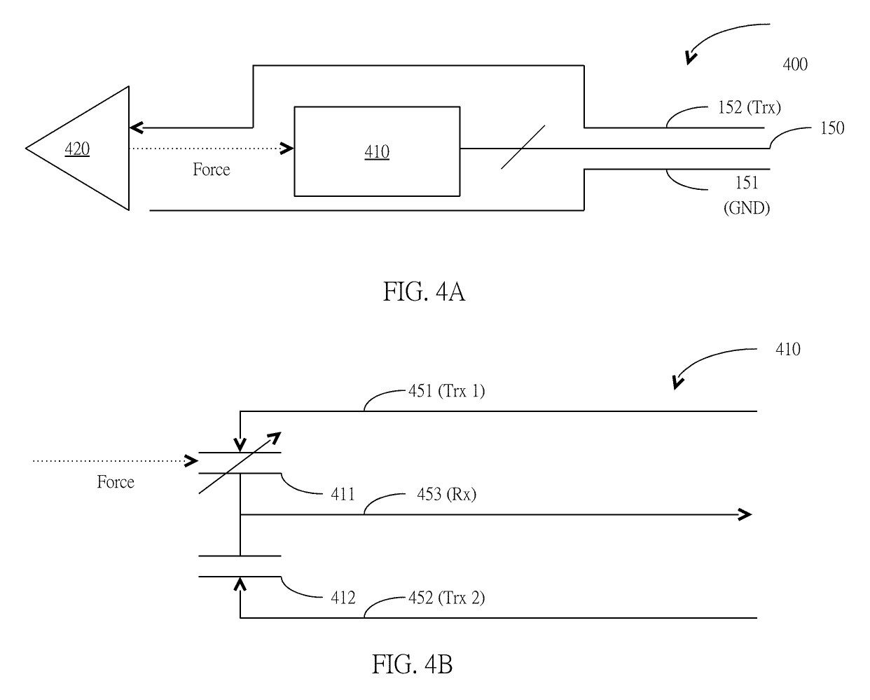

Referring to FIG. 4A, a block diagram depicting a tethered stylus 400 in accordance with an embodiment of the present invention is shown. At the right hand side of the tethered stylus 400 is a bus connection, which includes the driving-signal line 152 (Trx) and the ground line 151 (GND) described earlier. The driving-signal line 152 is connected to the tip 420 of the stylus so as to allow the tip 420 to transmit a driving signal, which is then transmitted to the first and second electrodes 111 and 112. However, when the tip 420 is under pressure, the pressure will be transmitted to a pressure sensor 410 inside the stylus 400. The pressure sensor 410 measures the pressure and transmits the measurement back to the touch controller 120 via a wire 150 inside the bus connection. In other words, the touch controller 120 obtains the location of the stylus 400 through the various electrodes 111 and 112, but obtains the pressure value measured by the pressure sensor 410 through the wire 150 in the bus connection.

The pressure sensor 410 can be an active element or a passive element. In a preferred embodiment, the pressure sensor 410 is made of passive elements having a circuit diagram such as the one shown in FIG. 4B. The pressure sensor 410 shown in FIG. 4B includes a force sensitive capacitor (FSC) 411 and a standard capacitor 412. When the tip 420 is under pressure, the capacitance of the FSC 411 will change.

The pressure sensor 410 includes a first signal source 451 (Trx1), a second signal source 452 (Trx2), a first element (which can be the FSC) 411 having a first impedance Z1, and a second element 412 (which can be the standard capacitor) having a second impedance Z2. A first signal sent from the first signal source 451 (Trx1) is transmitted back to the touch controller 120 after passing through the first element/FSC 411 and a sensing line 453 (Rx). Similarly, a second signal sent from the second signal source 452 (Trx2) is transmitted back to the touch controller 120 after passing through the second element/standard capacitor 412 and the sensing line 453 (Rx).

In an embodiment, the first signal is a signal having a first frequency f1, and the second signal is a signal having a second frequency f2. The first frequency f1 and the second frequency f2 can be square-wave signals, sinusoidal-wave signals, or pulse-width-modulated signals. In an embodiment, the second frequency f2 is different from the first frequency f1.

The signals of the two frequencies are mixed together after respectively passing through the first element 411 having the first impedance Z1 and the second element 412 having the second impedance Z2, and is then fed to the sensing line 453 (Rx) to be transmitted to the touch controller 120. The first and second elements can be resistors, inductors, capacitors (e.g. solid-state capacitors) or any combinations of the above. In this embodiment, the second impedance Z2 remains constant, and the first impedance Z1 is variable and corresponds to the change in a particular sensor.

In another embodiment, both the first and second impedances Z1 and Z2 are variables, and the ratio of the two corresponds to the change in a particular sensor. In an embodiment, the sensor can be an adjustable elastic stylus tip 420. The first impedance Z1 may change accordingly with the displacement of or the pressure experienced by the elastic stylus tip 420. In some examples, the first impedance Z1 is linearly related to a change in a physical quantity of the sensor. However, in other examples, the first impedance Z1 is non-linearly related to a change in a physical quantity of the sensor.

The first and second elements 411 and 412 can be different types of electronic elements. For example, the first element 411 can be a resistor, whereas the second element 412 can be a capacitor, or vice versa. Alternatively, the first element 411 can be a resistor, and the second element 412 an inductor, or vice versa. Alternatively, the first element 411 can be an inductor, and the second element 412 a capacitor, or vice versa. At least one of the first and second impedances Z1 and Z2 can be variable, such as a variable resistance, a variable capacitance or a variable impedance. When one of the first and second impedances Z1 and Z2 stays constant, it can be provided using an existing electronic element, such as a standard resistor with a constant resistance, a standard capacitor with a constant capacitance or a standard inductor with a constant inductance.

In an embodiment, the first element 411 is a force sensing resistor (FSR), its resistance produces predictable changes according to the forces experienced, while the second element 412 can be a constant resistor. In another embodiment, the first element can be 411 a variable resistor. Therefore, with all other conditions being the same, in the electrical signals received by the sensing line 453 (Rx), the ratio of the magnitude M1 of the signal component of the first frequency f1 and the magnitude M2 of the signal component of the second frequency f2 will be inversely related to the ratio of the first impedance Z1 and the second impedance Z2. In other words, M1/M2=k(Z2/Z1).

Thus, when the stylus 400 is suspending above the touch screen 110, and the tip 420 of the stylus has no displacement or is not under any force, in the electrical signal Rx detected by the touch controller 120, the ratio of the magnitude M1 of the signal component of the first frequency f1 and the magnitude M2 of the signal component of the second frequency f2 is a constant or a default value. Alternatively, in another embodiment, (M1−M2)/(M1+M2) or (M2−M1)/(M1+M2) is a constant or a default value. Alternatively, M1/(M1+M2) or M2/(M1+M2) can be used to represent the pressure value. In addition to the above four types of ratios, one with ordinary skill in the art can appreciate that any ratios involving the magnitudes M1 and M2 can be used instead. In other words, when the ratio is detected to be constant, then it can be determined that the sensor has not sensed any change in the physical quantity. In an embodiment, this means that the stylus 400 is not touching the touch screen 110.

When the stylus 400 is in contact with the touch screen 110, the tip 420 experiences a force. The first impedance Z1 of the first element 411 with the first impedance Z1 then changes according to the amount of force experienced by the tip 420, such that a change in the ratio of the magnitude M1 of the signal component of the first frequency f1 and the magnitude M2 of the signal component of the second frequency f2 in the electrical signal Rx that is different from the constant or the default value mentioned before also occurs. The touch controller 120 thus produces a corresponding sensed value based on the ratio using the above relationship. The constant or default value is not limited to a single numerical value, but can be a series of values within an error tolerance range.

It should be noted that this ratio and the sensed value do not necessary have a linear relationship. To illustrate further, the sensed value and the displacement of or force experienced by the sensor do not necessary have a linear relationship, either. The sensed value is merely a value sensed by the touch controller 120, and the present invention does not limit the relationships between them. For example, the touch controller 120 may use a lookup table or a plurality of formulae to associate the ratio with the sensed value.

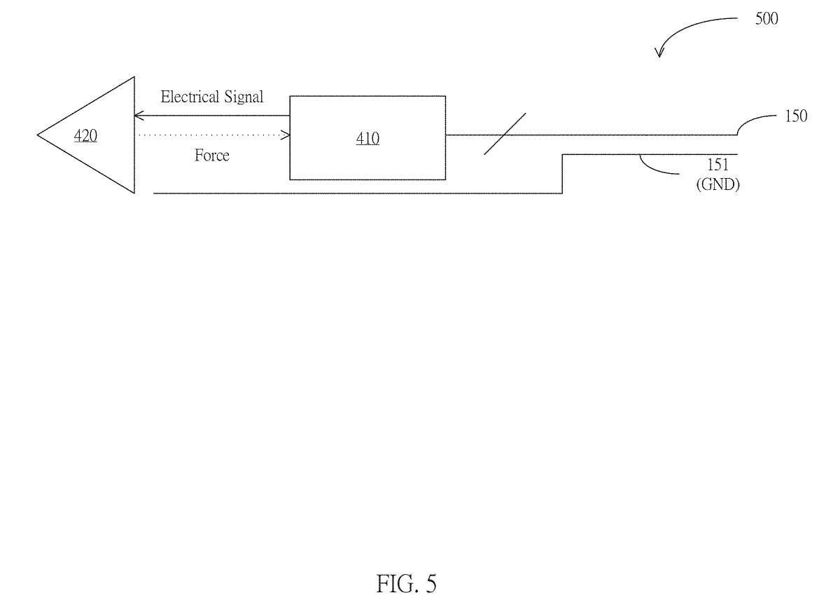

Referring to FIG. 5, a schematic diagram depicting a stylus 500 in accordance with an embodiment of the present invention is shown. Compared to the embodiment of FIG. 4, the tip 420 of the stylus of FIG. 5 no longer receives driving signals from the dedicated driving-signal line 151, rather it receives electrical signals from the pressure sensor 410.

The touch controller 120 can detect electrical signals coming from the tip 420 through the first and second electrodes 111 and 112 to further obtain the proximity/touch location of the stylus tip 420. As to pressure values experienced by the stylus tip 420, they may come from electrical signals emitted from the stylus tip 420, or from sensed values returned by the pressure sensor 410 from the bus connection.

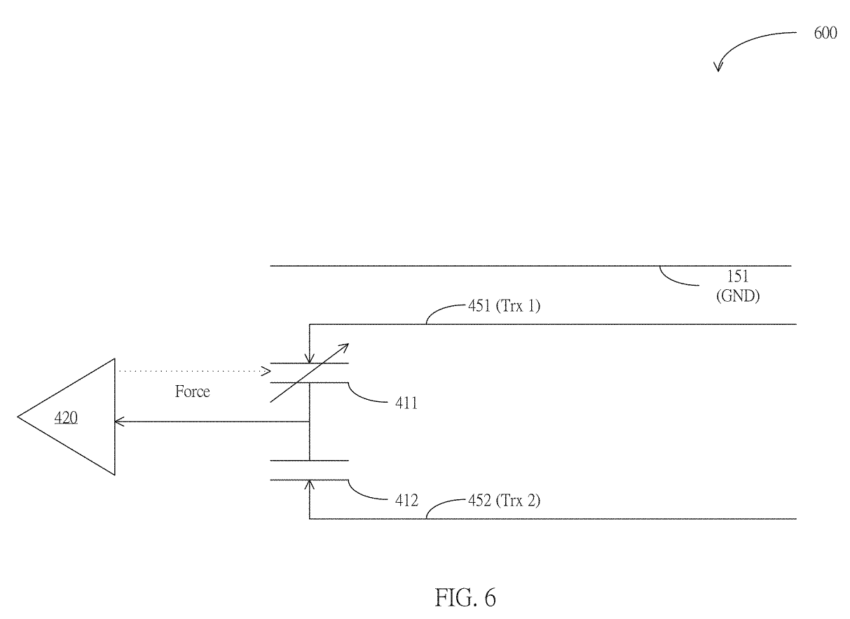

Referring to FIG. 6, a schematic diagram depicting a stylus 600 in accordance with an embodiment of the present invention is shown, which is also a variation of the embodiment in FIG. 5. The tip of the stylus 420 receives an electrical signal of mixed frequencies from the first and second elements 411 and 412, and transmits it to the first and second electrodes 111 and 112. Similar to the principle described with respect to FIG. 4B, the touch controller 120 is able to determine whether the stylus 600 is suspending in the air based on the ratio of the magnitude M1 of the signal component of the first frequency f1 and the magnitude M2 of the signal component of the second frequency f2 in the received electrical signal. If the stylus 600 is in contact with the touch screen 110, then based on the ratio relationship of the magnitudes, a corresponding sensed pressure value can be produced.

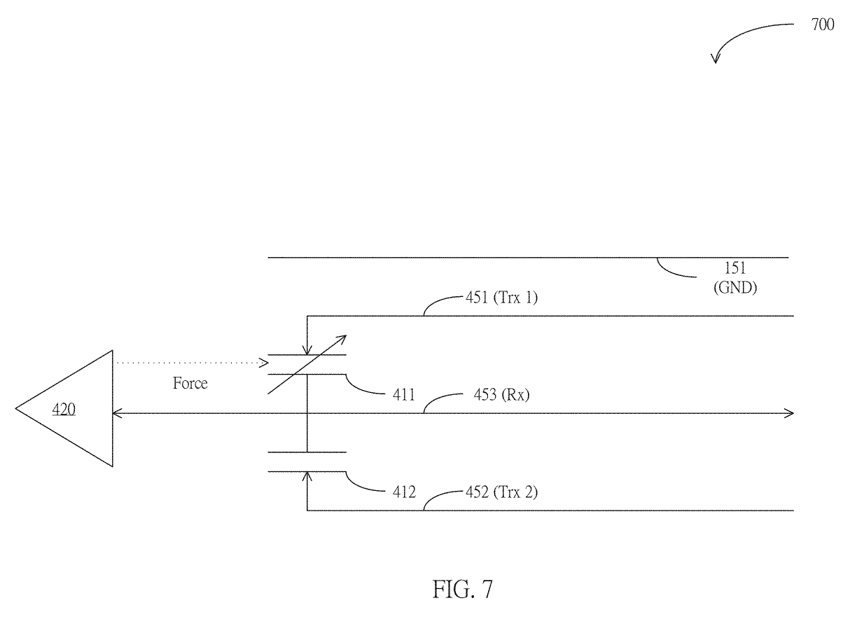

Referring to FIG. 7, a schematic diagram depicting a stylus 700 in accordance with an embodiment of the present invention is shown, which is also a variation of the embodiment in FIG. 5. The tip of the stylus 420 receives an electrical signal of mixed frequencies from the first and second elements 411 and 412, and transmits it to the first and second electrodes 111 and 112. In addition, the signal with the mixed frequencies is also transmitted back to the touch controller 120 through a sensing line 453 (Rx). Similar to the principle described with respect to FIG. 4B, the touch controller 120 is able to determine whether the stylus 700 is suspending in the air based on the ratio of the magnitude M1 of the signal component of the first frequency f1 and the magnitude M2 of the signal component of the second frequency f2 in the electrical signal received via the sensing line 453 (Rx). If the stylus 700 is in contact with the touch screen, then based on the ratio relationship of the magnitudes, a corresponding sensed pressure value can be further produced. Similar to FIG. 4B, the touch controller 120 detects the location of the stylus 700 through the various electrodes 111 and 112, but obtains a pressure value measured by the pressure sensor 410 through the wire 150 inside the bus connection.

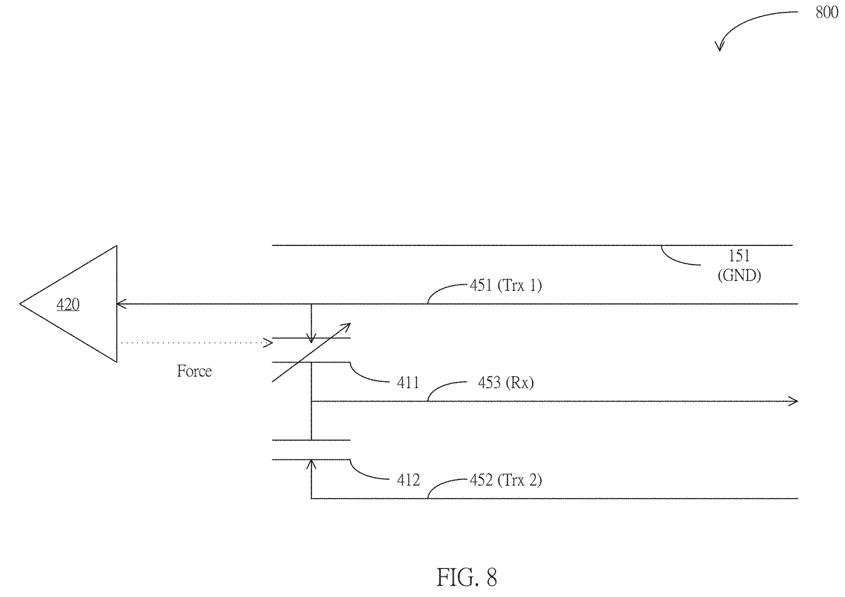

Referring to FIG. 8, a schematic diagram depicting a stylus 800 in accordance with an embodiment of the present invention is shown, which is also a variation of the embodiment in FIG. 5. The tip of the stylus 420 receives an electrical signal of mixed frequencies from the first and second elements 411 and 412, and transmits it to the first and second electrodes 111 and 112. In addition, the signal with the mixed frequencies is also transmitted back to the touch controller 120 through a sensing line 453 (Rx). Similar to the principle described with respect to FIG. 4B, the touch controller 120 is able to determine whether the stylus 800 is suspending in the air based on the ratio of the magnitude M1 of the signal component of the first frequency f1 and the magnitude M2 of the signal component of the second frequency f2 in the electrical signal received via the sensing line 453 (Rx). If the stylus 800 is in contact with the touch screen, then based on the relationship of the ratios of the magnitudes, a corresponding sensed pressure value can be further produced. Similar to FIG. 4B, the touch controller 120 detects a location of the stylus 800 through the various electrodes 111 and 112, but obtains a pressure value measured by the pressure sensor 410 through the wire 150 inside the bus connection.

The difference between FIGS. 8 and 7 is in the electrical signals emitted by the tip of the stylus 420. However, the touch controllers 120 obtain pressure values measured by the pressure sensors 420 through the wires 150 inside the bus connections, so the calculations for the sensed pressure values stay the same.

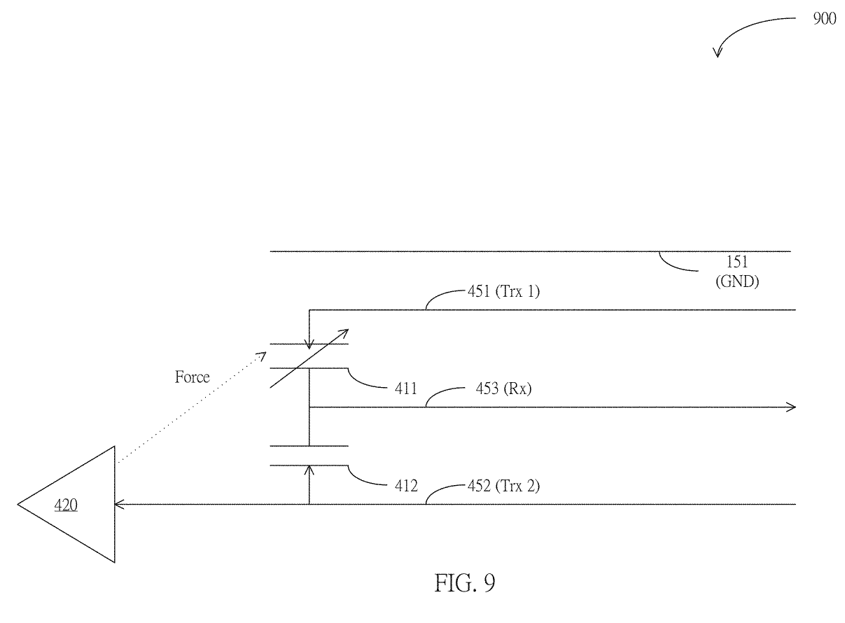

Referring to FIG. 9, a schematic diagram depicting a stylus 900 in accordance with an embodiment of the present invention is shown, which is also a variation of the embodiment in FIG. 5. The tip of the stylus 420 receives an electrical signal of mixed frequencies from the first and second elements 411 and 412, and transmits it to the first and second electrodes 111 and 112. In addition, the signal with the mixed frequencies is also transmitted back to the touch controller 120 through a sensing line 453 (Rx). Similar to the principle described with respect to FIG. 4B, the touch controller 120 is able to determine whether the stylus 900 is suspending in the air based on the ratio of the magnitude M1 of the signal component of the first frequency f1 and the magnitude M2 of the signal component of the second frequency f2 in the electrical signal received via the sensing line 453 (Rx). If the stylus 900 is in contact with the touch screen, then based on the relationship of the ratios of the magnitudes, a corresponding sensed pressure value can be further produced. Similar to FIG. 4B, the touch controller 120 detects a location of the stylus 900 through the various electrodes 111 and 112, but obtains a pressure value measured by the pressure sensor 410 through the wire 150 inside the bus connection.

The difference between FIGS. 9 and 7 is in the electrical signals emitted by the tip of the stylus 420. However, the touch controllers 120 obtain pressure values measured by the pressure sensors 410 through the wires 150 inside the bus connections, so the calculations for the sensed pressure values stay the same.

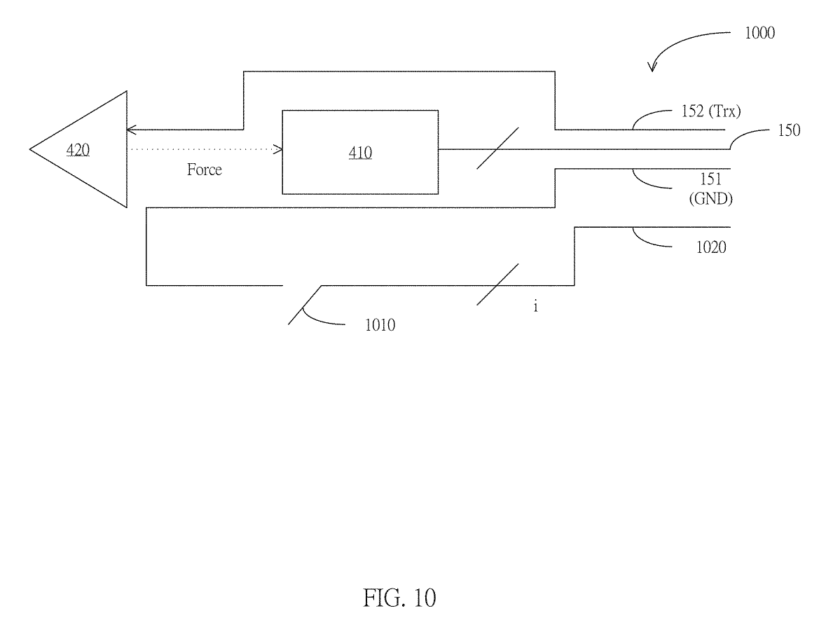

Referring to FIG. 10, a schematic diagram depicting a stylus 1000 in accordance with an embodiment of the present invention is shown, which is also a variation of the embodiment in FIG. 4. The difference between FIGS. 10 and 4 is in that at least one (or i) button 1010 is added onto the stylus 1000. When the button 1010 is pressed, the touch controller 120 detects a circuit is turned on, and in turns know that the button 1010 is being pressed. The bus connection in FIG. 10 has i more wires 1020 than the bus connection in FIG. 4, wherein i represents the number of buttons, and can be zero or a positive number.

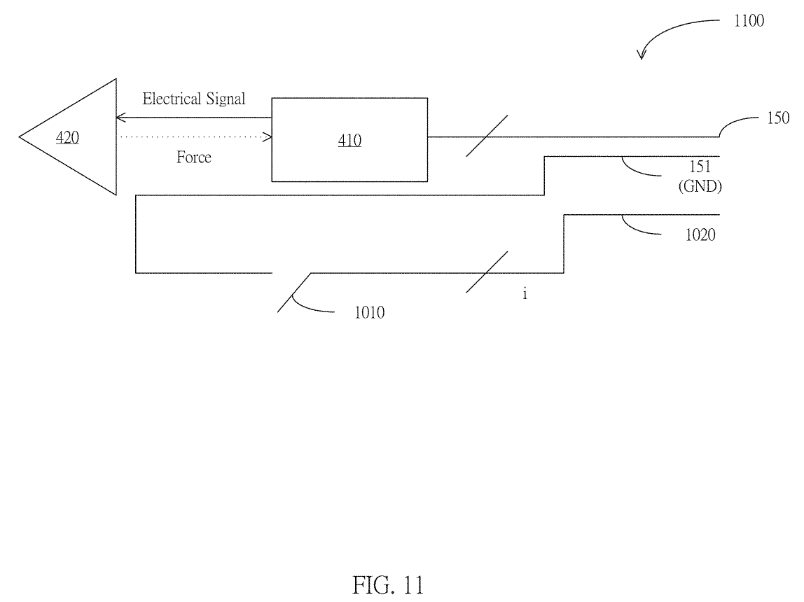

Referring to FIG. 11, a schematic diagram depicting a stylus 1100 in accordance with an embodiment of the present invention is shown, which is also a variation of the embodiment in FIG. 5. The difference between FIGS. 11 and 5 is in that at least one (or i) button 1010 is added onto the stylus 1100. When the button 1020 is pressed, the touch controller 120 detects a circuit is turned on, and in turns know that the button is being pressed. The bus connection in FIG. 11 has i more wires 1020 than the bus connection in FIG. 5, wherein i represents the number of buttons, and can be zero or a positive number. It should be noted that the variation shown in FIG. 11 can be equally applied to the embodiments shown in FIGS. 6 to 9.

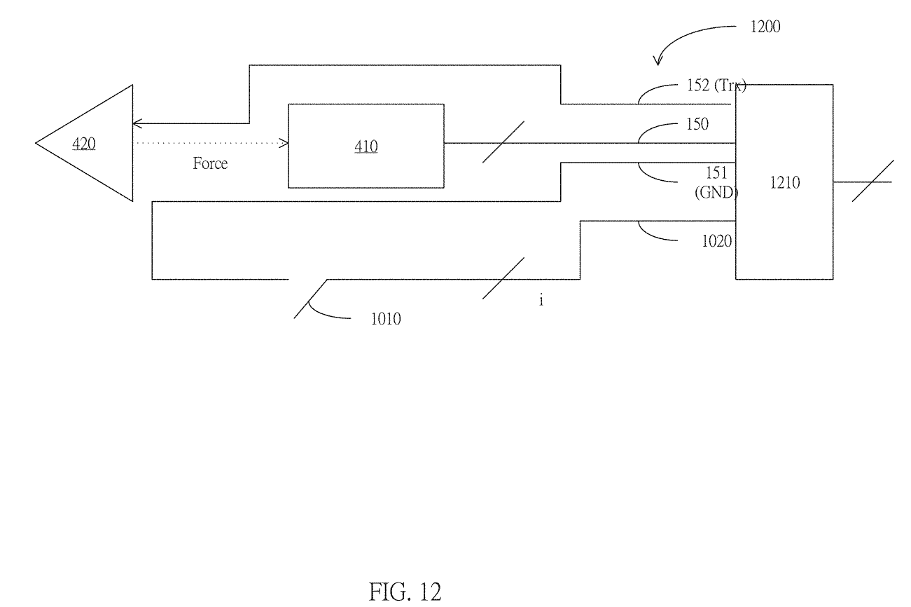

Referring to FIG. 12, a schematic diagram depicting a stylus 1200 in accordance with an embodiment of the present invention is shown, which is also a variation of the embodiment in FIG. 10. The difference between FIGS. 12 and 10 is in that an onboard controller 1210 is added to the stylus 1200. The onboard controller 1210 can be connected to the touch controller 120 using an existing interface, such as USB, RS-232, RS-422, IEEE 1394, External PCI-E, External SATA, iSCSI, or etc. In an embodiment, the onboard controller 1210 is connected to the touch controller 120 using a proprietary interface.

The onboard controller 1210 can be connected to the tip 420, the pressure controller 410, and/or various buttons 1010 of the stylus in ways similar to those shown in FIG. 4 or FIG. 10, and the sensed pressure value is transmitted to the touch controller 120 via the interface.

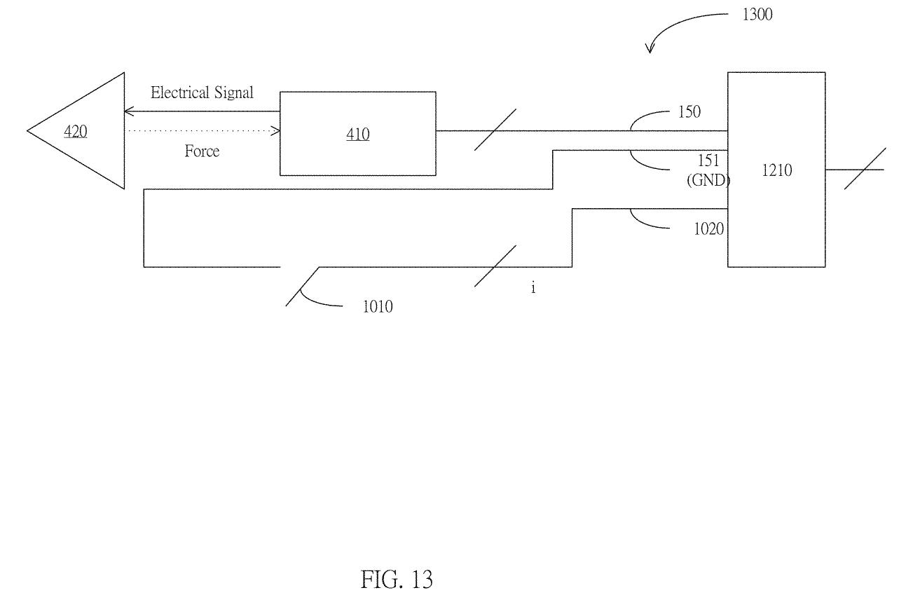

Referring to FIG. 13, a schematic diagram depicting a stylus 1300 in accordance with an embodiment of the present invention is shown, which is also a variation of the embodiment in FIG. 11. The difference between FIGS. 13 and 11 is in that an onboard controller 1210 is added to the stylus 130. The onboard controller 1210 can be connected to the touch controller 120 using an existing interface, such as USB, RS-232, RS-422, IEEE 1394, External PCI-E, External SATA, iSCSI, or etc. In an embodiment, the onboard controller 1210 is connected to the touch controller 120 using a proprietary interface.

The onboard controller 1210 can be connected to the pressure controller 410 and/or various buttons 1010 of the stylus in ways similar to those shown in FIG. 4 or FIG. 10, and the sensed pressure value is transmitted to the touch controller 120 via the interface. It should be noted that the variation shown in FIG. 13 can be equally applied to the embodiments shown in FIGS. 6 to 9.

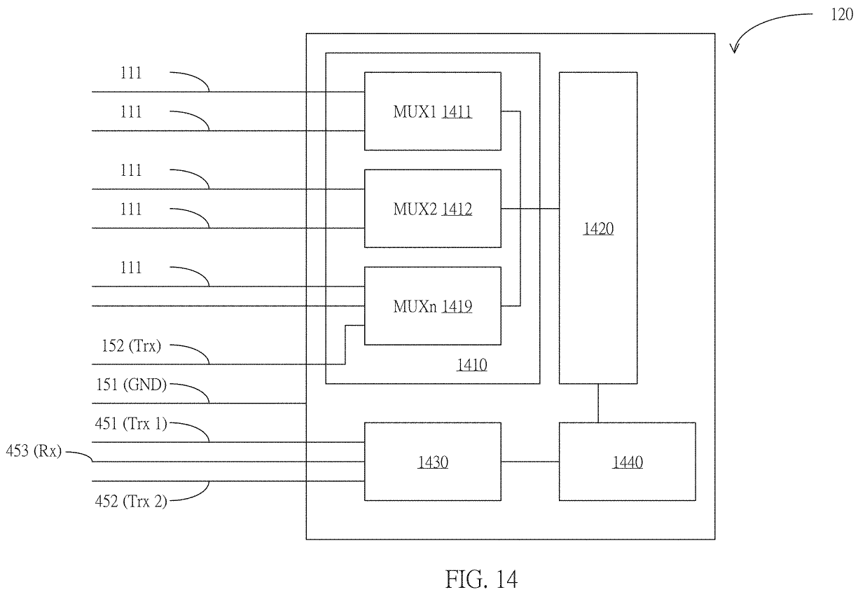

Referring to FIG. 14, a schematic diagram depicting the inside of the touch controller 120 in accordance with an embodiment of the present invention is shown. The touch controller 120 includes a processor 1440 and a driving circuit 1420 controlled by the processor 1440, a multiplexing circuit module 1410 and an optional pressure sensor 1430. The driving circuit 1420 is used for generating a driving signal upon receiving an instruction from the processor 1440. The multiplexing circuit module 1410 is used for sequentially transmitting the driving signal to each of the first electrodes 111 on the touch screen 110 and the driving-signal line 152 in the stylus 130 in a time-division multiplexing manner upon receiving an instruction from the processor 1440. In an embodiment, the multiplexing circuit module 1410 includes a plurality of multiplexers 1411, 1412 and 1419; the present invention does not limit the number of multiplexers in the multiplexing circuit module 1410, as long as each of the first electrodes 111 and the driving-signal line 152 is connected to a multiplexer.

In an embodiment, the touch controller 120 includes a signal receiving portion (not shown) for receiving a sensed driving signal received by each of the second electrodes 112 to determine if a finger is approaching and the location of the finger. The signal receiving portion (not shown) is used for receiving a sensed driving signal received by each of the first electrodes 111 and the second electrodes 112 to determine if there is a stylus 130 approaching the touch screen 110 and the location of proximity/touch of the stylus.

In an embodiment, the touch controller 120 further includes the pressure sensor 1430 for providing the first signal source 451 and the second signal source 452 and receiving a sensed pressure value from the sensing line 453. The detection principles of the pressure sensor 1430 are demonstrated in the various embodiments above.

In an embodiment, the multiplexing circuit module 1410 of the touch controller 120 does not need to connect with the driving-signal line 152, the stylus 130 may use the first signal source 451 and the second signal source 452 to transmit electrical signals. When a driving signal is provided to the driving-signal line, the signal receiving portion (not shown) is used for determining if a stylus 130 is approaching the touch screen 110 and the location of the proximity/location of the stylus based on an electrical signal including the first signal source 451 and the second signal source 452 sensed by each of the first electrodes 111 and each of the second electrodes 112.

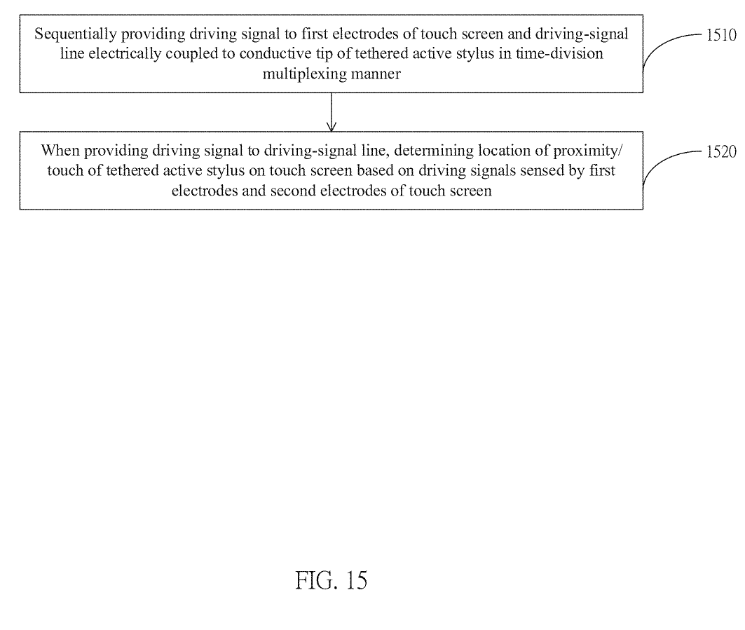

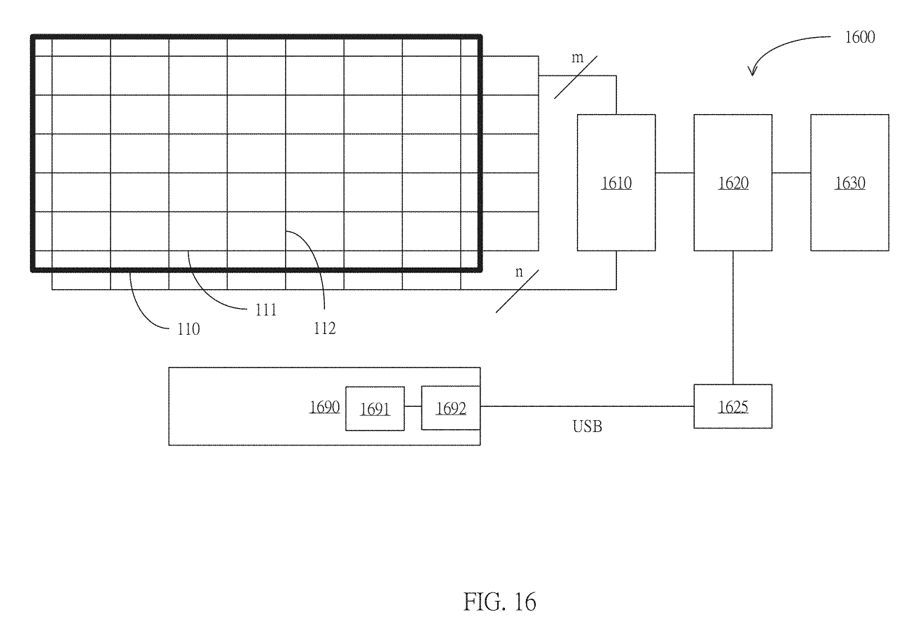

Referring to FIG. 15, a flowchart illustrating a touch control method in accordance with the present invention is shown, which includes: in step 1510, sequentially providing a driving signal to a plurality of first electrodes of a touch screen and a driving-signal line electrically coupled to a conductive tip of a tethered active stylus in a time-division multiplexing manner; and in step 1520, when the driving signal is provided to the driving-signal line, determining a location of a proximity/touch of the tethered active stylus on the touch screen based on the driving signals sensed by the plurality of first electrodes and a plurality of second electrodes of the touch screen. Referring to FIG. 16, a block diagram illustrating an electronic apparatus 1600 in accordance with an embodiment of the present invention is shown. The electronic apparatus includes the touch screen 110 such as the one shown in FIG. 1. There are a plurality of parallel first electrodes 111 and a plurality of parallel second electrodes 112 on the touch screen 110, forming a plurality of intersections thereon. The electronic apparatus 1600 further includes a touch controller 1610 connected with the first electrodes 111 and the second electrodes 112. The touch controller 1610 may include a microprocessor or an embedded processor for executing programs in order to perform touch functions for the touch screen 110. The touch functions include detecting the proximity or touch (proximity/touch hereinafter) of an external conductive object on the touch screen 110. The external conductive object may be, for example, a finger or a stylus 1690 that actively transmits electrical signals.

Different from the touch controller 120 shown in FIG. 1 or FIG. 14, the touch controller 1610 does not directly provide a driving signal to the stylus 1690, but instructs the stylus 1690 to transmit a driving signal via a tethered connection network 1620. In the embodiment shown in FIG. 16, the tethered connection network 1620 may be a network structure compliant to Universal Serial Bus (USB). The electronic apparatus 1600 may include at least one USB host, it may also include a client or hub connected to the host. In this embodiment, the touch controller 1610 includes a USB client for connecting to the host. An onboard controller 1691 of the stylus 1690 includes another USB client, which is connected to an USB electronic apparatus connector 1625 via a USB stylus connector 1692, which is turn connected to the host in the tethered connection network 1620. The stylus connector 1692 and the electronic apparatus connector 1625 may be a Type-A, a Type-B or a Type-C connector, or the like.

Although the connection inside the tethered connection network 1620 is not explicitly shown in FIG. 16, one with ordinary skill in the art can appreciate that the touch controller 1610 and the onboard controller 1691 may communicate with each other via the tethered connection network 1620 with reference to the USB standard. In other examples, the tethered connection network 1620 may have a network structure compliant with RS-232, RS-422, IEEE 1394, External PCI-E, External SATA, or iSCSI standard or the like. The present invention does not limit the connection protocol or standard used by the tethered connection network 1620, the touch controller 1610 and the onboard controller 1691, however, the wires between the stylus connector 1692 and the electronic apparatus connector 1625 and the two connectors themselves are external wires susceptible to external electromagnetic interference. If an industry-compliant standard is used, this not only reduces the influence of electromagnetic interference, but also the cost for design and production. As the stylus 1690 requires flexible movements, a cable with less wires and shorter diameter is a more preferable embodiment of the present invention.

The electronic apparatus 1600 may further include a processor module 1630 connected to the tethered connection network 1620 above. The processor module 1630 may include a CPU for executing an operating system, a memory, a memory controller, an I/O device connected to the tethered connection network 1620, and the like. One with ordinary skill in the art may appreciate the various variations of the processor module 1630. In an embodiment, the operating system of the electronic apparatus 1600 includes a driver for the touch controller, acting as a bridge between the operating system and the touch controller 1610. In another embodiment, a stylus driver may also be installed in the operating system of the electronic apparatus 1600 for acting as a bridge between the operating system and the stylus 1690. In yet another embodiment, the touch controller driver and the stylus driver can work together and exchange information between the touch controller 1610 and the onboard controller 1691 in the stylus. One with ordinary skill in the art can appreciate that the present invention does not limit the types of software and hardware arrangements under which the touch controller 1610 and the onboard controller 1691 in the stylus exchange information.

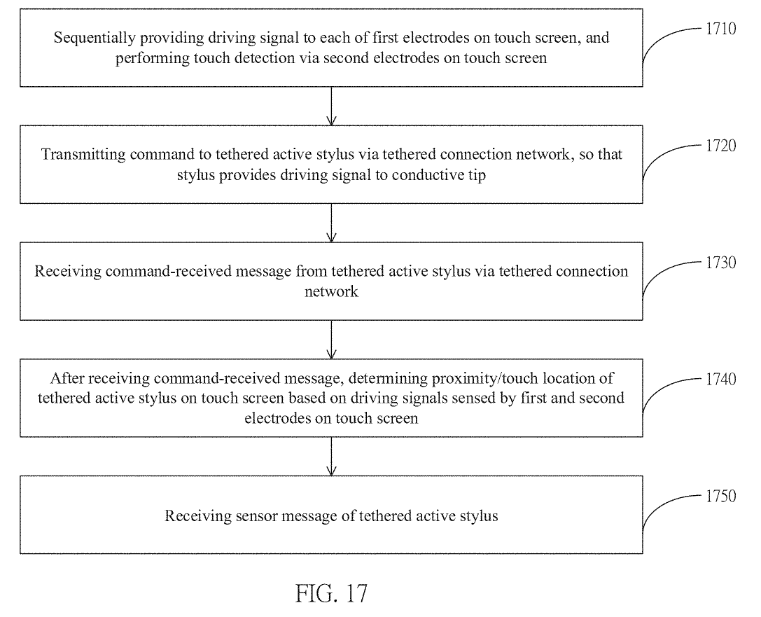

Referring to FIG. 17, a flowchart illustrating a control method for a touch controller in accordance with an embodiment of the present invention is shown. The embodiment shown in FIG. 17 can be applied to the embodiment shown in FIG. 17, where mutual capacitive detection and active stylus detection are performed, but the present invention does not require that the active stylus detection mode has to be performed after the mutual capacitive detection mode, it neither requires the execution of the mutual capacitive detection mode, as long as the detection of an active stylus can be carried out using the embodiments above.

At the start of the method in FIG. 17, an optional mutual capacitive step 1710 is performed, where a driving signal is sequentially provided to each of a plurality of first electrodes on a touch screen, and touch detection is performed via a plurality of second electrodes on the touch screen. In step 1720, an active stylus detection mode is performed, wherein a command is sent to a tethered active stylus via a tethered connection network, so that the stylus provides a driving signal to a conductive tip. As described before, this driving signal can be the same as or different from the driving signal in mutual capacitive mode in step 1710. If the two are the same, then the same detection circuit or software/hardware arrangements for step 1710 can be repeatedly used. If they are different, the driving signal in step 1720 can be modified according to actual implementations to facilitate the detection of the active stylus. The present invention does not require the driving signals of these two steps to be the same or different from each other.

Step 1730 is optional. When the command is sent to the tethered active stylus in step 1720, the active stylus or an onboard controller may return a corresponding command-received message. Thus, in step 1730, a command-received message from the active stylus or an onboard controller is received via the tethered connection network.

Part of step 1740 is also optional. If an acknowledgement mechanism is present, then after the command-received message is received, a proximity/touch location of the tethered active stylus on the touch screen is determined based on driving signals sensed by the plurality of first and second electrodes on the touch screen. If no acknowledgement mechanism is present, then after a certain period has elapsed since step 1720 is performed, the touch controller may carry out the latter half of the step 1740, that is, a proximity/touch location of the tethered active stylus is determined based on driving signals sensed by the plurality of first and second electrodes on the touch screen.

Step 1750 is also optional. In an embodiment, the touch controller may receive a sensor message of the tethered active stylus based on the electrical signals received in step 1740. In another embodiment, the touch controller may receive a sensor message delivered by the tethered active stylus via a wire using the active stylus or the onboard controller. In other words, the touch controller may skip step 1750, or it may receive the sensor message of the tethered active stylus in a wireless or tethered manner.

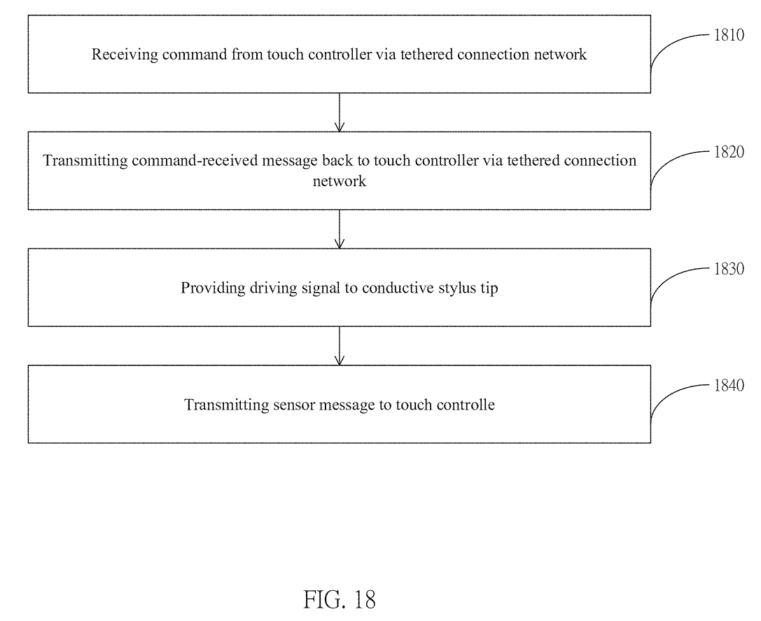

Referring to FIG. 18, a flowchart illustrating a control method of an onboard controller in accordance with an embodiment of the present invention is shown. This can be applied to the embodiment shown in FIG. 16, or used together with the method shown in FIG. 17. The method begins at step 1810, wherein a command is received from a touch controller via a tethered connection network.

Step 1820 is optional, in which a command-received message is transmitted back to the touch controller via the tethered connection network. If step 1820 is not performed, then method proceeds to step 1830, wherein, at a certain time after the message, a driving signal is provided to a conductive stylus tip. Step 1840 is also optional, wherein a sensing result, such as a pressure value at tip and/or a button status, from sensor(s) in the stylus is received by an onboard controller, and a sensor message is transmitted to the touch controller via the tethered connection network.

In accordance with an embodiment, a tethered active stylus is provided, including: a conductive tip; and a driving-signal line electrically coupled to the conductive tip, wherein the driving-signal line is connected to a driving circuit of a touch controller, and the driving circuit sequentially provides a driving signal to a plurality of electrodes on a touch screen connected with the touch controller and the driving-signal line in a time-division multiplexing manner.

In the above embodiment, the driving signals provided to the plurality of electrodes and the driving-signal line are the same.

In the above embodiment, the tethered active stylus further includes a ground line electrically coupled to a ground potential of the touch controller. In an example, the tethered active stylus further includes a conductive core electrically coupled between the conductive tip and the driving-signal line; a core insulating material surrounding the conductive core; and a core shielding element surrounding the core insulating material, the core shielding element is conductive and electrically coupled to the ground line. In an example, a portion of the core insulating material near the conductive tip is not covered by the core insulating element. In an example, a portion of the core insulating material near the conductive tip protrudes from the body of the stylus. In an example, the tethered active stylus further includes i switches. Each switch is located between the ground line and a switch line of the touch controller, wherein i is a positive integer.

In the above embodiment, the tethered active stylus further includes a pressure sensor for sensing a force experienced at the conductive tip and transmitting a force value experienced at the conductive tip back to the touch controller via a wire. In an example, the pressure sensor includes: a first element having a first impedance that changes with the force experienced for receiving a first signal including a first frequency group; a second element having a second impedance that does not change with the force experienced for receiving a second signal including a second frequency group; and a sensing line for receiving output signals from the first element and the second element. In an example, the force value returned by the sensing line is represented by a ratio of the signal strength M1 of the first frequency group and the signal strength M2 of the second frequency group.

In accordance with an embodiment, a tethered active stylus is provided, including: a conductive tip; and a pressure sensor including: a first element having a first impedance that changes with the force experienced for receiving a first signal including a first frequency group from a touch controller; and a second element having a second impedance that does not change with the force experienced for receiving a second signal including a second frequency group from the touch controller; wherein the conductive tip is at least coupled to one of the first element and the second element.

In the above embodiment, the pressure sensor further includes a sensing line for transmitting the force experience at the conductive tip back to the touch controller. In an example, the sensing line receives output signals from the first element and the second element, and the force value returned by the sensing line is represented by a ratio of the signal strength M1 of the first frequency group and the signal strength M2 of the second frequency group.

In the above embodiment, the tethered active stylus further includes a ground line electrically coupled to a ground potential of the touch controller. In an example, the tethered active stylus further includes i switches. Each switch is located between the ground line and a switch line of the touch controller, wherein i is a positive integer.

In accordance with an embodiment of the present invention, a touch controller is provided, including: a driving circuit; and a multiplexing circuit module for sequentially providing a driving signal provided by the driving circuit to a plurality of first electrodes on a touch screen and a driving-signal line electrically coupled with a conductive tip of a tethered active stylus in a time-division multiplexing manner.

In the above embodiment, the multiplexing circuit module further includes a first multiplexing circuit for connecting a portion of the plurality of first electrodes; and a second multiplexing circuit for connecting another portion of the plurality of first electrodes and the driving-signal line.

In the above embodiment, the touch controller further includes a sensing circuit connected to a plurality of second electrodes and the plurality of first electrodes on the touch screen for determining, when the driving signal is provided by the driving circuit, a location of proximity/touch of the tethered active stylus based on driving signals sensed from the plurality of first electrodes and the plurality of second electrodes.

In accordance with an embodiment of the present invention, a touch control method is provided, including: sequentially providing a driving signal to a plurality of first electrodes on a touch screen and a driving-signal line electrically coupled with a conductive tip of a tethered active stylus in a time-division multiplexing manner; and determining, when the driving signal is provided to the driving-signal line, a location of proximity/touch of the tethered active stylus based on driving signals sensed from the plurality of first electrodes and the plurality of second electrodes.

In accordance with an embodiment of the present invention, a touch control system is provided, including: a tethered active stylus and a touch controller. The tethered active stylus includes a conductive tip; and a driving-signal line electrically coupled to the conductive tip. The touch controller includes: a driving circuit; and a multiplexing circuit module for sequentially providing a driving signal provided by the driving circuit to a plurality of first electrodes on a touch screen and the driving-signal line in a time-division multiplexing manner.

In the above embodiment, the tethered active stylus further includes a ground line electrically coupled to a ground potential of the touch controller. In an example, the tethered active stylus further includes a conductive core electrically coupled between the conductive tip and the driving-signal line; a core insulating material surrounding the conductive core; and a core shielding element surrounding the core insulating material, the core shielding element is conductive and electrically coupled to the ground line. In an example, the core insulating material near the conductive tip is not covered by the core insulating element. In an example, the core insulating material near the conductive tip protrudes from the body of the stylus. In an example, the tethered active stylus further includes i switches. Each switch is located between the ground line and a switch line of the touch controller, wherein i is a positive integer. In the above embodiment, the tethered active stylus further includes a pressure sensor for sensing a force experienced at the conductive tip and transmitting a force value experienced at the conductive tip back to the touch controller via a wire. In an example, the pressure sensor includes: a first element having a first impedance that changes with the force experienced for receiving a first signal including a first frequency group; a second element having a second impedance that does not change with the force experienced for receiving a second signal including a second frequency group; and a sensing line for receiving output signals from the first element and the second element. In an example, the force value returned by the sensing line is represented by a ratio of the signal strength M1 of the first frequency group and the signal strength M2 of the second frequency group.

In the above embodiment, the touch control system further includes a connection interface between the touch controller and the tethered active stylus for electrically coupling the driving-signal line. In an example, the connection interface is further used for electrically coupling the ground line.

In accordance with an embodiment of the present invention, a touch controller is provided, including: an electrode interface for connecting with a plurality of first electrodes and a plurality of second electrodes on a touch screen for sensing a driving signal from a tethered active stylus; a connection network interface for connecting with the tethered active stylus via a tethered connection network; and a processing module connected to the electrode interface and the connection network interface for sending a command to the tethered active stylus via the connection network interface such that the stylus provides the driving signal; and determining a location of proximity/touch of the tethered active stylus via the driving signal sensed by the electrode interface. One advantage of this embodiment is to provide a touch controller having a tethered network interface to allow easy connection of a tethered active stylus also having a tethered network interface.

In the above embodiment, the processing module is further used to sequentially providing a mutual capacitive driving signal to the plurality of first electrodes in a time-division multiplexing manner, and performing mutual capacitive detection via the plurality of second electrodes. One advantage of this embodiment is that it provides mutual capacitive detection. In an example, the driving signal is equivalent to the mutual capacitive driving signal. One advantage of this embodiment is that the same software or hardware arrangements can be used for detecting the mutual capacitive driving signal and the driving signal of the tethered active stylus that are the same.

In the above embodiment, the processing module is further used for receiving a command-received message from the tethered active stylus via the tethered connection network; and upon receiving the command-received message; and determining a location of proximity/touch of the tethered active stylus on the touch screen based on the driving signal sensed by the electrode interface. One advantage of this embodiment is to provide a synchronization mechanism between the touch controller and the tethered active stylus.

In the above embodiment, the processing module is further used for receiving a sensor message of the tethered active stylus according to one of the following methods: receiving the sensor message of the tethered active stylus via the connection network interface; and receiving the sensor message of the tethered active stylus via the driving signal sensed by the electrode interface. One advantage of this embodiment is to provide a sensor message of the tethered active stylus.

In the above embodiment, the tethered connection network includes one of the following: USB, RS-232, RS-422, IEEE 1394, External PCI-E, External SATA and iSCSI. One advantage of this embodiment is to provide a replaceable tethered active stylus that is compliant with the industry standards.

In accordance with an embodiment of the present invention, a touch control method is provided, including: transmitting a command to a tethered active stylus, such that the stylus provides a driving signal to its conductive tip; and determining a location of proximity/touch of the tethered active stylus via driving signals sensed from a plurality of first electrodes and a plurality of second electrodes on a touch screen. One advantage of this embodiment is to provide a touch control method having a tethered network interface to allow easy connection of a tethered active stylus also having a tethered network interface.

In the above embodiment, the control method is further used for sequentially providing a mutual capacitive driving signal to the plurality of first electrodes in a time-division multiplexing manner, and performing mutual capacitive detection via the plurality of second electrodes. One advantage of this embodiment is that it provides mutual capacitive detection. In an example, the driving signal is equivalent to the mutual capacitive driving signal. One advantage of this embodiment is that the same software or hardware arrangements can be used for detecting the mutual capacitive driving signal and the driving signal of the tethered active stylus that are the same.

In the above embodiment, the control method is further used for receiving a command-received message from the tethered active stylus via the tethered connection network; and upon receiving the command-received message; and determining a location of proximity/touch of the tethered active stylus on the touch screen based on the driving signal sensed by the electrode interface. One advantage of this embodiment is to provide a synchronization mechanism between the touch controller and the tethered active stylus.

In the above embodiment, the control method is further used for receiving a sensor message of the tethered active stylus according to one of the following methods: receiving the sensor message of the tethered active stylus via the connection network interface; and receiving the sensor message of the tethered active stylus via the driving signal sensed by the electrode interface. One advantage of this embodiment is to provide a sensor message of the tethered active stylus.

In the above embodiment, the tethered connection network includes one of the following: USB, RS-232, RS-422, IEEE 1394, External PCI-E, External SATA and iSCSI. One advantage of this embodiment is to provide a replaceable tethered active stylus that is compliant with the industry standards.

In accordance with an embodiment of the present invention, a tethered active stylus is provided, including: a connection network interface for connecting to a touch controller via a tethered connection network; a conductive tip for transmitting a driving signal; and an onboard controller connected to the connection network interface and the conductive tip for receiving a command from the touch controller via the tethered connection network; and providing the driving signal to the conductive tip. One advantage of this embodiment is to provide a replaceable tethered active stylus that is compliant with the industry standards.

In the above embodiment, the onboard controller is further used for, after receiving the command, transmitting a command-received message to the touch controller via the tethered connection network. One advantage of this embodiment is to provide a synchronization mechanism between the touch controller and the tethered active stylus.

In the above embodiment, the onboard controller is further used for transmitting a sensor message to the touch controller via the tethered connection network. One advantage of this embodiment is to provide a sensor message of the tethered active stylus.

In the above embodiment, the tethered connection network includes one of the following: USB, RS-232, RS-422, IEEE 1394, External PCI-E, External SATA and iSCSI. One advantage of this embodiment is to provide a replaceable tethered active stylus that is compliant with the industry standards.

In accordance with an embodiment of the present invention, a control method for a tethered active stylus is provided, including: receiving a command from a touch controller; and providing a driving signal to a conductive tip. One advantage of this embodiment is to provide a replaceable tethered active stylus that is compliant with the industry standards.

In the above embodiment, the control method is further used for, after receiving the command, transmitting a command-received message to the touch controller via the tethered connection network. One advantage of this embodiment is to provide a synchronization mechanism between the touch controller and the tethered active stylus.

In the above embodiment, the control method is further used for transmitting a sensor message to the touch controller via the tethered connection network. One advantage of this embodiment is to provide a sensor message of the tethered active stylus.

In the above embodiment, the tethered connection network includes one of the following: USB, RS-232, RS-422, IEEE 1394, External PCI-E, External SATA and iSCSI. One advantage of this embodiment is to provide a replaceable tethered active stylus that is compliant with the industry standards.

In accordance with an embodiment of the present invention, an electronic apparatus is provided, including: a touch controller connected to a tethered connection network and a tethered active stylus. The touch controller includes: an electrode interface for connecting with a plurality of first electrodes and a plurality of second electrodes on a touch screen for sensing a driving signal from the tethered active stylus; a connection network interface for connecting with the tethered active stylus via a tethered connection network; and a processing module connected to the electrode interface and the connection network interface for sending a command to the tethered active stylus via the connection network interface such that the stylus provides the driving signal; and determining a location of proximity/touch of the tethered active stylus via the driving signal sensed by the electrode interface. The tethered active stylus includes: a connection network interface for connecting to the touch controller via the tethered connection network; a conductive tip for transmitting a driving signal; and an onboard controller connected to the connection network interface and the conductive tip for receiving a command from the touch controller via the tethered connection network; and providing the driving signal to the conductive tip. One advantage of this embodiment is to provide a replaceable tethered active stylus that is compliant with the industry standards.

What is claimed is:

1. A tethered active stylus comprising:
a conductive tip; and
a driving-signal line electrically coupled to the conductive tip, wherein the driving-signal line is connected to a driving circuit of a touch controller, and the driving circuit sequentially provides a driving signal to a plurality of electrodes on a touch screen connected with the touch controller and the driving-signal line in a time-division multiplexing manner.

2. The tethered active stylus of claim 1, wherein the driving signals provided to the plurality of electrodes and the driving-signal line are the same.

3. The tethered active stylus of claim 1, further comprising a ground line electrically coupled to a ground potential of the touch controller.

4. The tethered active stylus of claim 1, further comprising:
a conductive core electrically coupled between the conductive tip and the driving-signal line;
a core insulating material surrounding the conductive core; and
a core shielding element surrounding the core insulating material, the core shielding element being conductive and electrically coupled to the ground line.

5. The tethered active stylus of claim 4, wherein a portion of the core insulating material near the conductive tip is not covered by the core insulating element.

6. The tethered active stylus of claim 4, wherein a portion of the core insulating material near the conductive tip protrudes from the body of the tethered active stylus.

7. The tethered active stylus of claim 3, further comprising i switches, each switch being located between the ground line and a switch line of the touch controller, wherein i is a positive integer.

8. The tethered active stylus of claim 1, further comprising a pressure sensor for sensing a force experienced at the conductive tip, and transmitting a force value experienced at the conductive tip back to the touch controller via a wire.

9. The tethered active stylus of claim 8, wherein the pressure sensor further includes:
a first element having a first impedance that changes with the force experienced for receiving a first signal including a first frequency group;
a second element having a second impedance that does not change with the force experienced for receiving a second signal including a second frequency group; and
a sensing line for receiving output signals from the first element and the second element.

10. The tethered active stylus of claim 9, wherein a force value returned by the sensing line is represented by a ratio of the signal strength M1 of the first frequency group and the signal strength M2 of the second frequency group.
